(19) United States
(12) Patent Application Publication
(10) Pub. No.: US 2024/0343486 A1
(43) Pub. Date: Oct. 17, 2024

(54) Modularized Warehousing System

(71) Applicant: Hangzhou HC Information Tech Co Ltd., Huzhou (CN)

(72) Inventors: Junda Zhu, Huzhou (CN); Zheng Zou, Huzhou (CN); Rui Xu, Huzhou (CN); Sen Cai, Huzhou (CN)

(21) Appl. No.: 18/638,629

(22) Filed: Apr. 17, 2024

(30) Foreign Application Priority Data
Apr. 17, 2023 (CN) 202310402845

(51) Int. Cl. B65G 1/04

(52) U.S. Cl. CPC B65G 1/0492; B65G 2207/30

(57) ABSTRACT

A modularized warehousing system, the modularized warehousing system comprises a driving device, a carrying device and a plurality of warehousing modules, each warehousing module comprises a goods shelf body and a track, and the track comprises a vertical track and a horizontal track; the modular warehousing system has an expansion mode and a single block mode, and in the single block mode, the driving device drives the carrying device to move along the vertical track or the horizontal track; in the expansion mode, during transverse expansion, the horizontal rails of the adjacent storage modules are connected with each other, during vertical expansion, the storage modules have a connection state and a non-connection state, and in the connection state, the vertical rails of the adjacent storage modules are connected with each other; and in the non-connection state, the vertical rails of the adjacent storage modules are mutually staggered.

### BACKGROUND

At present, the logistics industry is developing rapidly, and the degree of automation has been greatly enhanced. Coupled with the increase in the frequency of various e-commerce promotional activities, the current warehousing situation is difficult to maintain in a relatively stable state like in the traditional business era. It is necessary to frequently adjust the warehousing scale according to the number of orders generated by e-commerce promotions. At the same time, customers have different needs for storage. Some customers are cost-oriented and are willing to sacrifice part of storage efficiency, while some customers are efficiency-oriented and are willing to relax cost requirements. At the same time, due to the different storage spaces of customers, it is difficult to unify the size specifications of all storage shelves. If customized according to the needs of each customer, although the needs of most customers can be met, the high cost of customization and mold opening is unacceptable for logistics and warehousing suppliers.

### SUMMARY

In order to solve the aforementioned problems, the present patent disclosure provides a modular storage system, which can take into account the various needs of different customers and the various storage spaces of different customers, and at the same time reduce the production cost of the storage system.

In order to achieve the above object, the present patent disclosure adopts the following technical scheme:

A modular storage system, including a driving device, a handling device and several storage modules, each storage module includes a shelf body and a track arranged on the shelf body; the track includes a vertical track and a horizontal track;

The modular storage system has an extended mode and a single block mode:

In the single block mode, the driving device drives the handling device to move along the vertical track or the horizontal track, and the handling device moves out or puts in goods from the shelf body;

In the expansion mode, when the modular storage system expands horizontally, the horizontal rails of adjacent storage modules connect with each other, and when the modular storage system expands vertically, it has a connected state and a non-connected state: in the connected state, the vertical rails of adjacent storage modules are connected to each other, and the driving device drives the handling device to move along the horizontal rails connected to each other and/or the vertical rails connected to each other; in the non-connected state, the adjacent storage modules The vertical rails are staggered from each other, and the driving device drives the conveying device to move along the connected horizontal rails; the conveying device carries out or puts in goods from the shelf body.

The technical solution provided by the present patent disclosure modularizes the storage system so that the entire storage shelf system is split into various storage modules, and each storage module is processed separately. When the customer is sensitive to cost, only one set of handling devices can be used. When the customer requires efficiency, multiple sets of handling devices can be added, and even each storage module can be equipped with a set of handling devices. In this way, the needs of different customers can be taken into account. At the same time, due to the modularization of the storage system, the storage shelves can be adaptively expanded according to the storage space of different customers. Even if the storage space of the customer is irregular, the space can be maximized. This is an advantage that the integrated storage system cannot have. While meeting customer needs and using space efficiently, thanks to the advantages of modularization, storage system suppliers do not need to customize storage systems according to customer storage space and customer needs, and may not need to open multiple molds, but only need to open the storage module once. The mold is enough, and the production cost has been effectively reduced. In addition, still benefiting from the advantages of modularization, the transportation is more convenient and the transportation cost is also reduced.

Optionally, the driving device includes a vertical driving device, the conveying device is detachably arranged on the vertical driving device, and the vertical driving device drives the conveying device to ascend or descend along the vertical track.

The vertical driving device provides partial movement in the vertical direction for the conveying device, and the conveying device is detachably arranged on the vertical driving device, which is convenient for maintenance of the conveying device.

Optionally, the cooperation between the vertical driving device and the vertical track is a rack and pinion or a sprocket chain.

In the prior art, there are many matching methods that can realize linear drive, such as rack-and-pinion matching, belt drive matching, and ball screw cooperation, among which belt drive matching is further divided into friction belt drive matching and synchronous belt drive matching. The inventor found through in-depth research that for the friction belt transmission mode, it can only be made into a closed loop structure in one storage module. In this way, it is impossible to realize the vertical track of the vertical drive device between adjacent storage modules. across. Although the synchronous belt drive can be made into a non-closed and non-circulating structure, the synchronous belt must be tightened. If the synchronous belt is tightened, the synchronous belt can only be pulled from the two ends of the vertical track to the backside of the vertical track to tighten it without making it into a closed loop in the storage module. After tensioning, although the linear transmission can be realized under the premise that the synchronous belt is not closed and does not circulate, the synchronous pulley has extremely high requirements for meshing. The two ends of the two ends go around to the back side of the vertical track, therefore, this will cause the adjacent vertical track ends to be unable to connect compactly. Once the connection cannot be compact, it is impossible to ensure that the tooth pitch of the synchronous belt adjacent to the two different vertical tracks at the joint is within the meshing requirements of the synchronous pulley. Then, when the vertical drive device needs to carry out vertical During the crossing of the track, it will inevitably lead to the inability to complete the crossing due to the inability to mesh the positions between the adjacent vertical rails. However, when the techniques described herein are actually used, the adjacent vertical rails are not always in the state of alignment, and the state of engagement and disjoint change in real time according to the actual situation. Therefore, due to reasons such as installation accuracy, transmission error, and vibration, it is inevitable This makes it impossible for the vertical rails between adjacent storage modules to meet the meshing requirements of the synchronous pulleys when they enter the engagement state.

The transmission method of the ball screw requires the rotation of the screw to complete the linear drive. However, when the vertical rails between adjacent storage modules enter the connected state from the non-connected state, it is also impossible to ensure that the connection between two adjacent lead screws can meet the transmission requirements of the nuts. Even if the problem of connecting adjacent lead screws is solved regardless of the cost, if the storage system has a high vertical extension, the rigidity of several lead screws connected to each other cannot be guaranteed. If the stiffness cannot be guaranteed, the vibration of the lead screw will be aggravated, which will cause the nut to drive poorly or even be damaged. Therefore, the method of the ball screw cannot meet the core demand of the vertical drive device to span the vertical rails between adjacent storage modules, no matter in terms of feasibility or cost.

Therefore, the inventor has selectively used the transmission mode of the rack and pinion and the sprocket chain. For the transmission method of rack and pinion, the rack has a certain rigidity, and it does not need to be made into a closed transmission, nor does it need to be tightened. At the same time, the meshing requirements of the gears are much lower than those of the synchronous belt. This also means that when the storage module is manufactured, the adjacent racks can be made into a relatively complete size that meets the gear meshing requirements, and then installed on different vertical rails respectively. When the adjacent storage modules When the vertical rails between them enter the connected state from the non-connected state, as long as the vertical rails are aligned, the adjacent racks can meet the meshing requirements of the gears, so that the vertical drive device can pass smoothly between adjacent storage modules. The vertical track completes the span. Regardless of the aspect of feasibility or cost, the core requirement of the vertical drive device to span the vertical track between adjacent storage modules can be met. For the transmission mode of the sprocket chain, since the chain type is a semi-rigid transmission link, the chain does not need to be tightened, and can be directly fixed by mechanical connection, which can also achieve the technical effect of the rack butt joint. Although the synchronous belt is also the way of meshing, since the synchronous belt is a flexible belt, it must be tightened during the transmission process of the flexible belt, and the flexible belt can only be driven by the transmission belt. Therefore, even if the synchronous belt is in the form of a chain The mechanical connection is fixed to the vertical track, but only the synchronous wheel is driven, and it still cannot move up and down. At the same time, it is also because the timing belt is a flexible belt, so after a long time of use, the timing belt will inevitably loosen. In this way, it is even more impossible to complete the up and down movement.

Moreover, the inventor also unexpectedly found that in order to meet the core requirement of the vertical drive device to cross the vertical track between adjacent storage modules, the power source can only be arranged in the rack and pinion or sprocket chain transmission mode. On one side of a gear or sprocket. It is precisely this centralized power layout that enables its control to be combined with the handling device to achieve centralized location. In this way, there is no need for electrical components on the vertical rails, so that the structural layout of the storage module can be more reasonable and compact, and avoid excessive wiring from affecting the stable operation of the storage system. At the same time, it is also convenient for maintenance. Under special circumstances, the old handling device can be directly removed, and the new handling device can be directly replaced to achieve rapid maintenance, and it is no longer necessary to disassemble the vertical track as a whole.

Optionally, the vertical track includes a vertical track profile, the vertical track profile has a vertical transmission bar installation groove, a rack or a chain is installed in the vertical transmission bar installation groove, and the vertical drive The device also has a first guide wheel in rolling contact with the outside of the installation groove of the vertical transmission bar, and the plane where the first guide wheel is located is parallel to the plane where the gear or sprocket is located.

Optionally, the vertical driving device also has a second guide wheel that is in rolling contact with the outside of the installation groove of the vertical transmission bar, and the plane where the second guide wheel is located is perpendicular to the plane where the gear or sprocket is located

In addition to providing the installation position for the rack or chain, the vertical transmission bar installation slot also provides guidance and support for the guide wheels of the vertical drive device, so that in a single storage module, the cooperation between the vertical drive device and the vertical track more stable. Moreover, the guide wheel provides guidance for the gear or sprocket of the vertical drive device from two directions, preventing the gear or sprocket from being disengaged from the rack. On the other hand, due to various reasons such as installation errors and manufacturing errors of the storage modules, when the vertical rails are in the connected state, although good docking between adjacent vertical rails can be achieved with the help of the characteristics of the rack or chain, the error is still It exists. Then, the first guide wheel and the second guide wheel can possess a certain degree of elasticity. When crossing the seam between adjacent vertical rails, the guide wheel contacts another vertical rail earlier than the gear or sprocket, and can pass through the guide wheel. The elasticity of the wheel itself overcomes the accumulated errors. At this time, the vertical driving device contacts two adjacent vertical rails simultaneously, creating good conditions for the smooth spanning of the gear or sprocket wheel.

Optionally, the vertical driving device includes a first wheel cover on which a gear or a sprocket is installed, and the first guide wheel and/or the second guide wheel are respectively detachably mounted on the first wheel cover.

The guide wheel and the first wheel cover are detachably installed. When the vertical drive device needs to be maintained, only the guide wheel needs to be removed to complete the disassembly of the vertical drive device, which is convenient for its maintenance.

Optionally, the driving device includes a horizontal driving device, the horizontal driving device is arranged on the vertical track, and is used to drive the vertical track to move in the horizontal direction, and then drive the conveying device to move in the horizontal direction.

The horizontal driving device provides partial movement in the horizontal direction for the entire vertical track and the vertical driving device on the vertical track, and also provides power for the conversion of the vertical track between the joint state and the non-joint state.

Optionally, the horizontal drive device is one of a meshing transmission device, a friction belt transmission device, a ball screw drive device, and a linear motor drive device, and the meshing transmission device is a rack and pinion transmission device, a sprocket chain transmission device. One of the synchronous belt transmission devices, wherein the rotating part in the meshing transmission device is used as a driving wheel, and the linear moving part is used as a driven part.

Optionally, the shelf body is provided with a horizontal track profile, and the horizontal track profile has a linear motion element installation groove for installing the linear motion element; the horizontal drive device also has a linear motion element installation groove The third guide wheel in rolling contact with the outer side, the plane where the third guide wheel is located is parallel to the plane where the driving wheel is located.

The beneficial effects of the guide wheels of the horizontal drive device are the same as those of the guide wheels of the vertical drive device, and will not be repeated here.

Optionally, the horizontal driving device includes a second wheel cover on which the driving wheel is installed, and the third guide wheel is detachably mounted on the second wheel cover.

The beneficial effect of the second wheel cover is the same as that of the first wheel cover, and will not be repeated here.

Optionally, the horizontal track also includes a horizontal guide track, the vertical track is provided with a crossbeam, the crossbeam is provided with a fourth guide wheel, and the fourth guide wheel cooperates with the horizontal guide track to guide and The vertical track is supported to move in the horizontal direction.

Through the horizontal guide track, the vertical guide track is supported and restrained during horizontal movement, avoiding unnecessary movement in other directions besides the required horizontal and horizontal movement, and also avoiding the vertical track from the storage module. disengage.

Optionally, a horizontal electric rail is provided on the side of the horizontal guide track, and a horizontal brush is provided on the crossbeam, and the driving device and the conveying device are separated from the horizontal electric rail by the horizontal brush. Get electricity.

Optionally, a vertical electric rail is provided on the side of the vertical rail, the vertical electric rail is electrically connected to the horizontal brush, the driving device is provided with a vertical brush, the handling device and The driving device obtains electric energy from the horizontal electric rail through the vertical electric brush and the horizontal electric brush by the vertical electric brush;

The end of the vertical electric rail is provided with a connecting part, and the connecting part is an insulator. In the connected state, the driving device travels from any storage module along the vertical track to the adjacent other along the vertical track. For one storage module, the vertical brush enters the vertical electric rail of another storage module through the connecting portion.

Due to the conductive effect of the vertical rails, when the vertical rails of the vertically adjacent storage modules are in the connected state, there must be a large gap between the vertical rails of the two vertical rails, because if Adjacent vertical rails are close together and arcing occurs. In order to ensure the safety of personnel and facilities, a sufficient safety distance must be left between adjacent vertical rails. And when the driving device reaches another adjacent storage module along the vertical track from one storage module, it must be ensured that the vertical brush can also cross from the vertical electric rail of one storage module to the vertical electric rail of another storage module. And because there is a safe distance between adjacent vertical rails, the vertical brush first enters the connecting part through the insulated connecting part, and then enters the vertical electric cabinet through the connecting part, which not only ensures the safe distance to avoid the discharge At the same time, it also ensures the smooth operation of the driving device across the storage modules.

These features and advantages of the techniques described herein will be disclosed in detail in the following specific embodiments and accompanying drawings. The best implementation mode or means of the techniques described herein will be shown in detail with reference to the accompanying drawings, but it is not intended to limit the technical solution of the techniques described herein. In addition, there are multiple features, elements, and components appearing in each of the following texts and drawings, and are marked with different symbols or numbers for convenience, but all represent parts with the same or similar structures or functions.

According to one innovative aspect of the subject matter being described in this disclosure, an example modularized storage system may comprise a storage rack, a plurality of horizontal rails coupled with the storage rack, a plurality of vertical rails coupled with the horizontal rails, a vehicle platform coupled with the vertical rails, and a handling vehicle, the handling vehicle configured to detach from the vehicle platform and handle items within the storage rack.

However, this list of features and advantages is not all-inclusive and many additional features and advantages are within the scope of the present disclosure. Moreover, it should be noted that the language used in the present disclosure has been principally selected for readability and instructional purposes, and not to limit the scope of the subject matter disclosed herein.

### BRIEF DESCRIPTION OF THE DRAWINGS

FIG. 1 is the schematic diagram of an example embodiment of the techniques described herein.

FIG. 2 is the synoptic diagram of track, driving device and handling device in the embodiment of an example embodiment of the techniques described herein.

FIG. 3 and FIG. 4 are the schematic diagrams of cooperation of the vertical track, the vertical drive device and the handling device in the embodiment of an example embodiment of the techniques described herein.

FIG. 5 is the schematic diagram of horizontal driving device in the embodiment of an example embodiment of the techniques described herein.

FIG. 6 is the schematic diagram of the horizontal guide track in an example embodiment of the techniques described herein.

### DETAILED DESCRIPTION

The technical solutions of the embodiments of the techniques described herein will be explained and described below in conjunction with the accompanying drawings of the embodiments of the present description, but the following embodiments are only preferred embodiments of the techniques described herein, not all of them. Based on the examples in the implementation manners, other examples obtained by those skilled in the art without making creative efforts all belong to the protection scope of the techniques described herein.

References in this specification to “one embodiment” or “example” or “example” mean that a particular feature, structure or characteristic described in connection with the embodiment itself may be included in at least one embodiment of the present patent disclosure. The appearances of the phrase “in one embodiment” in various places in the specification are not necessarily all referring to the same embodiment.

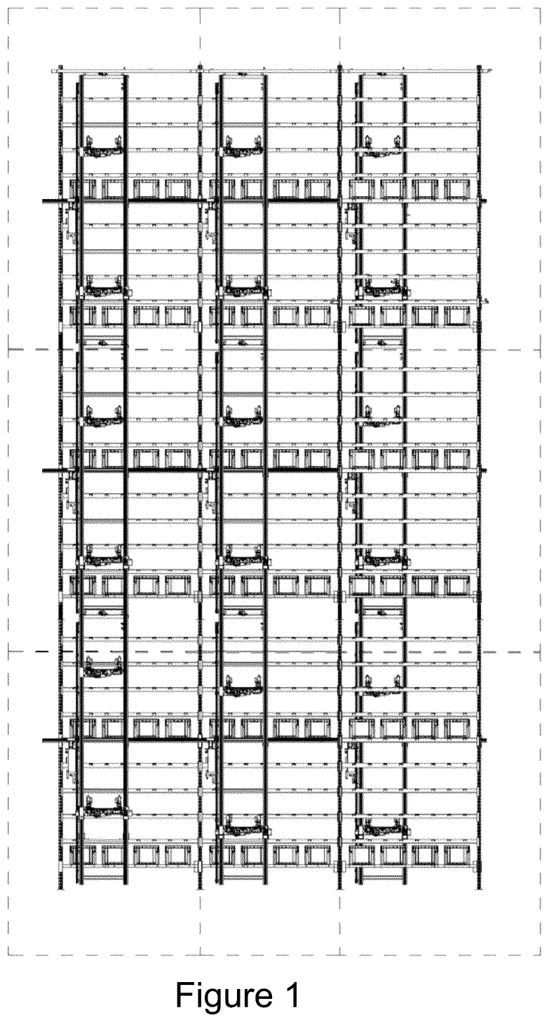

This embodiment provides a modular storage system, including a driving device and a handling device 6. As the name implies, the modular storage system provided in this embodiment is to modularly divide the overall storage system to form several storage modules. As shown in FIG. 1, each dotted box forms a storage module. Each storage module can be processed separately, and each storage module has the same size and structure. Therefore, only one mold opening of the storage module is required, and the production cost has been effectively reduced. Thanks to the modularization of the storage system, the storage shelves can be adaptively expanded according to the storage space of different customers. Even if the storage space of the customer is irregular, the space can be maximized. This is an advantage that the integrated storage system cannot have. While meeting customer needs and using space efficiently, thanks to the advantages of modularization, storage system suppliers do not need to customize storage systems according to customer storage space and customer needs, and may not need to open molds multiple times. In addition, they still benefit from modules. The advantages of modernization make transportation more convenient and also reduce transportation costs.

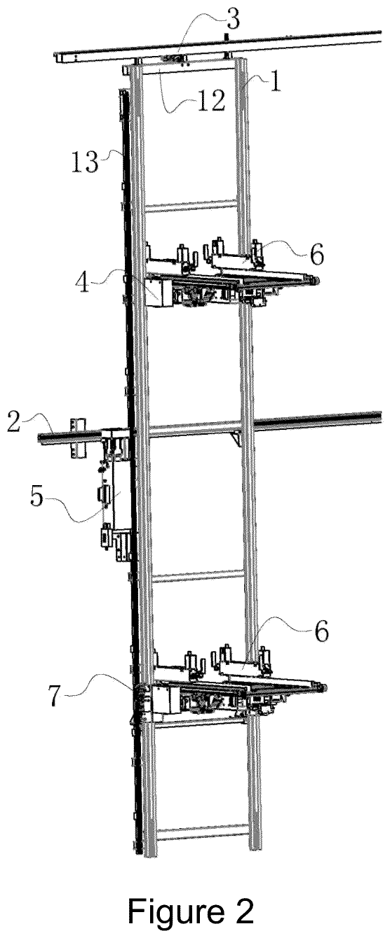

Each storage module comprises a shelf body and a track located at the shelf body; as shown in FIG. 2, the track includes a vertical track 1 and a horizontal track, and in the present embodiment, the horizontal track includes a horizontal power track 2 and a horizontal guide track 3. In other embodiments, the horizontal power track 2 can also be eliminated. The driving device includes a horizontal driving device 5 and a vertical driving device 4. In this embodiment, the conveying device 6 is a mechanical device commonly used in the art that can drag goods, which is not limited here. The basic structure of the vertical driving device 4 is the mechanical structure of the driving wheel driven by a motor, and matched with it, the cooperation between the vertical driving device 4 and the vertical track 1 is a rack and pinion or a sprocket chain. The cooperation between the horizontal driving device 5 and the horizontal power track 2 can be one of the meshing transmission device, friction belt transmission device, ball screw drive device, linear motor drive device, and other mechanical transmission devices that can realize linear transmission, such as air pressure Cylinders, hydraulic cylinders, etc., will not be repeated here. The meshing transmission device mentioned here is one of a rack and pinion transmission device, a sprocket chain transmission device, and a synchronous belt transmission device. When the linear motor driving device, the hydraulic cylinder transmission device and the pneumatic cylinder transmission device are used, the horizontal power track 2 is not needed. When adopting the ball screw transmission device, the leading screw is installed on the shelf body as the horizontal power track 2. When meshing transmission is used, the rotating part in the meshing transmission device is used as the driving wheel, the linear moving part is used as the driven part, the horizontal power track 2 is set on the shelf body, and the linear moving parts as the driven parts are racks, chains, etc. Or synchronous belt, as the rotating part of the drive wheel is a gear, sprocket or synchronous wheel. These three transmission methods are meshing transmission, so no need to go into details. When adopting the cooperation of the friction belt and the friction wheel, the horizontal transmission bar is a track with a certain friction coefficient, and the driving wheel is a friction wheel. At this time, the friction wheel and the friction belt need to be pressed tightly to realize the horizontal driving device 5 and the horizontal power. Drive fit for track 2.

For this reason, the vertical track 1 includes a vertical track profile 11, the vertical track profile 11 has a vertical transmission bar installation groove, a vertical rack or chain is installed in the vertical transmission bar installation groove, and the shelf body is provided with a horizontal The track profiles 21 and the horizontal track profiles 21 have installation grooves for linear motion parts, and racks, chains or synchronous belts are installed in the installation grooves for linear motion parts. In this embodiment, the cooperation between the vertical driving device 4 and the vertical track 1 and the cooperation between the horizontal driving device 5 and the horizontal power track 2 are all preferably in a rack and pinion mode. Therefore, in this embodiment, the description is also made in the manner of cooperation of the rack and pinion.

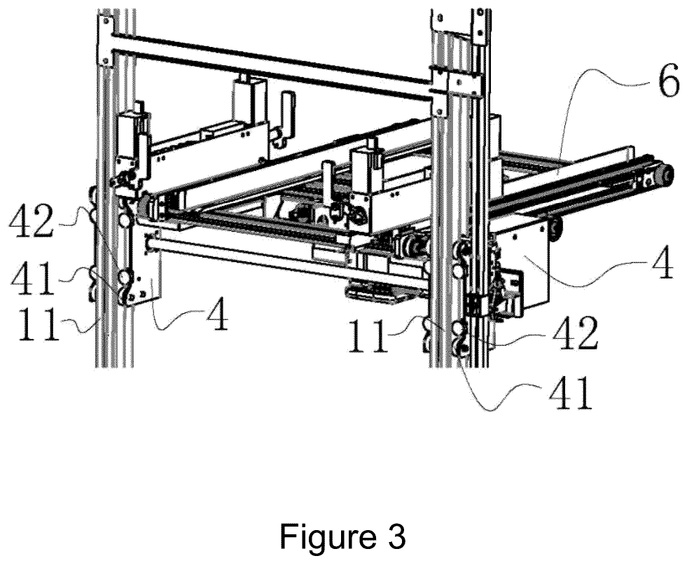

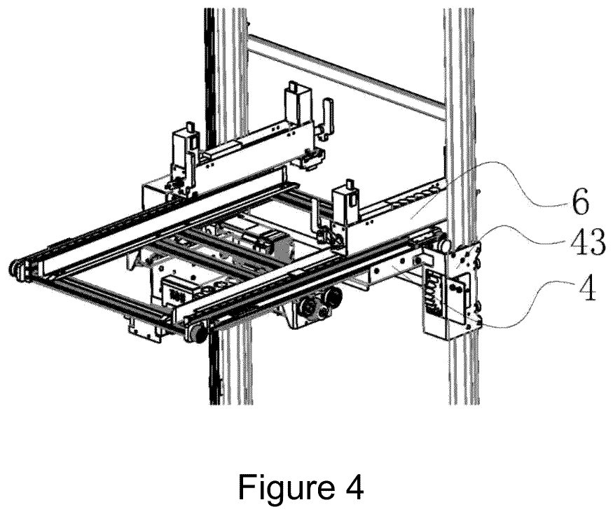

As shown in FIG. 3 and FIG. 4, vertical drive device 4 comprises first guide wheel 41, second guide wheel 42 and the first wheel cover 43 that is used to install gear, and the first wheel cover 43 is the vertical drive device 4 The gear installation provides the installation position and its support. The first guide wheel 41 and the second guide wheel 42 are detachably installed with the first gear cover 43 respectively. The disassembly of the vertical driving device 4 can be completed, which is convenient for its maintenance. The first guide wheel 41 and the second guide wheel 42 are in rolling contact with the outside of the vertical drive bar installation groove to provide guidance for the vertical drive device 4, wherein in this embodiment, the vertical rail profile 11 is in the shape of a “several”, the first The plane where the guide wheel 41 is located is parallel to the plane where the gear is located, and is in rolling contact with the bending of the “ [symbol] ” shape; In addition to providing installation positions for the racks or chains, the vertical transmission bar installation slot also provides guidance and support for the guide wheels of the vertical drive device 4, so that in a single storage module, the distance between the vertical drive device 4 and the vertical rail 1 The coordination between them is more stable. Moreover, the guide wheels provide guides for the gears of the vertical drive device 4 from two directions, and the first guide wheels 41 are in contact with the bends in the shape of “ [symbol] ” to prevent the gears from being disengaged from the rack. In this embodiment, the first guide wheels 41 are provided with 8, respectively at the four corners of the first wheel cover 43, in rolling contact with the two sides of the “several”-shaped bend, to further prevent the gear from moving from the rack. fall off. The conveying device 6 is detachably arranged on the vertical driving device 4, and the vertical driving device 4 drives the conveying device 6 to rise or fall along the vertical track 1, providing the conveying device 6 with a vertical movement, and the conveying device 6 is detachable It is arranged on the vertical driving device 4 to facilitate the maintenance of the conveying device 6. In other embodiments, only the first guide wheel 41 may be provided. When only the first guide wheel 41 is provided, the installation of the second guide wheel 42 can be canceled on the aforementioned basis.

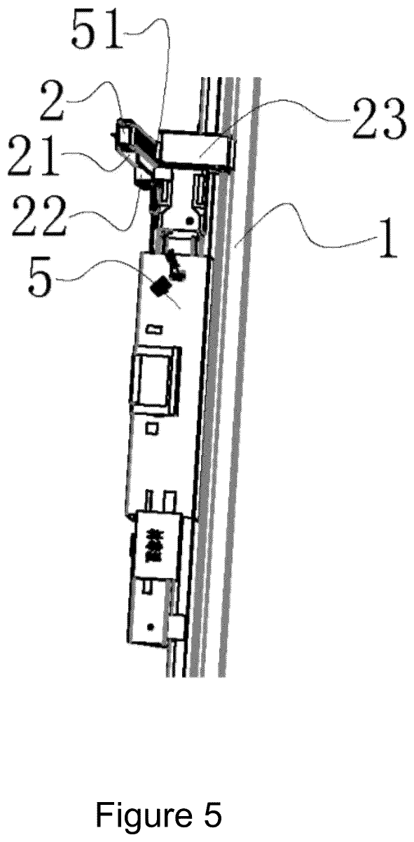

As shown in FIG. 5, similarly, the horizontal driving device 5 includes a third guide wheel 22 and a second wheel cover 23, and the second wheel cover 23 is used to install a gear 51 as a driving wheel, which is the gear 51 of the horizontal driving device 5 Or sprocket installation provides installation position and support thereof, and the 3rd guide wheel 22 and the 2nd wheel cover 23 detachable installations, when horizontal driving device 5 needs maintenance, only need to pull down the 3rd guide wheel 22, can finish pairing. The dismounting of horizontal driving device 5 is convenient for its maintenance. The third guide wheel 22 is in rolling contact with the outer side of the installation groove of the linear moving part, so as to provide guidance for the horizontal driving device 5. Wherein, the plane where the third guide wheel 22 is located is parallel to the plane where the gear 51 is located. In addition to providing a mounting position for the rack or chain, the linear moving part installation groove also provides guidance and support for the guide wheels of the horizontal driving device 5, so that the cooperation between the horizontal driving device 5 and the horizontal power track 2 is more stable. Moreover, the third guide wheel 22 can prevent the gear 51 from being disengaged from the rack or the sprocket from being disengaged from the chain to a certain extent, except that the third guide wheel 22 provides guidance for the gear 51 or the sprocket of the horizontal driving device 5. The horizontal drive device 5 is arranged on one side of the vertical track 1, and the horizontal drive device 5 cooperates with the horizontal power track 2 to drive the vertical track 1 to move in the horizontal direction, and then drives the handling device 6 to move in the horizontal direction, forming the entire vertical track. 1 and the vertical drive device 4 on the vertical track 1 provide sub-movement in the horizontal direction.

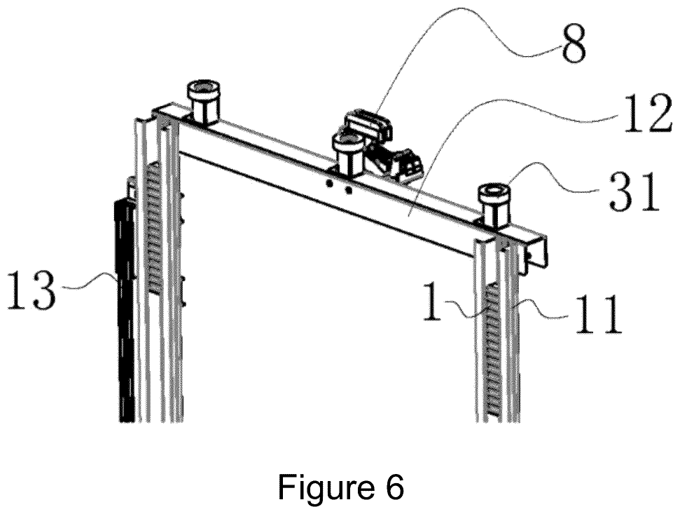

As shown in FIG. 6, in addition, vertical track 1 is provided with crossbeam 12, and crossbeam 12 is provided with the 4th guide wheel 31, and horizontal track also comprises horizontal guide track 3, and the 4th guide wheel 31 and horizontal guide track 3 Cooperate, guide and support the vertical track 1 to move in the horizontal direction, so that the vertical guide track is supported and restrained when it moves horizontally, so as to avoid unnecessary movement in other directions besides the required horizontal and horizontal movement, and at the same time It can also further prevent the vertical rail 1 from being disengaged from the storage module.

The modular storage system provided by this embodiment has an expansion mode and a single-block mode. In the single-block mode, each storage module is used as a shelf alone, and the driving device drives the handling device 6 to move along the vertical track 1 or the horizontal track. Device 6 moves out or puts in goods from the shelf body.

In the expansion mode, the modular storage system provided by this embodiment can be expanded horizontally and vertically, and the expansion in the two directions does not affect each other. When expanding horizontally, the horizontal rails of adjacent storage modules are connected to each other, while when expanding vertically, they have a connected state and a non-connected state. As the name implies, in the connected state, the vertical rails 1 of adjacent storage modules are connected to each other; while in the non-connected state, the vertical rails 1 of adjacent storage modules are staggered. The conversion of the vertical track 1 between the engagement state and the non-engagement state is completed by the cooperation of the horizontal driving device 5 and the horizontal power track 2 to push the vertical track 1. Since the vertical rails 1 of vertically adjacent storage modules are connected to each other in the connected state, the driving device drives the transport device 6 to move along the connected horizontal rails and/or the connected vertical rails 1 in the connected state; Since the vertical rails 1 of the vertically adjacent storage modules in the connected state are staggered from each other, the driving device can only drive the transport device 6 to move along the horizontal rails connected to each other in the non-joint state; then the transport device 6 moves from the shelf body Move out or put in goods. If the customer is sensitive to cost, the overall storage system can only use one set of handling devices 6 to reduce costs; if the customer requires efficiency, the overall storage system can be equipped with multiple sets of handling devices 6, or even each storage module can be equipped with one Cover the handling device 6 to improve the efficiency of goods operation. In this way, the needs of different customers can be taken into account. As shown in FIG. 1, in this embodiment, the efficiency-oriented approach is adopted, and multiple sets of driving devices and conveying devices 6 are equipped.

In the prior art, there are many matching methods that can realize linear drive. In addition to the selective use of rack and pinion matching and chain drive matching in this embodiment, it also includes belt drive cooperation and ball screw cooperation. Among them, belt drive cooperation It is further divided into friction belt drive fit and synchronous belt drive fit. The inventor found through in-depth research that for the friction belt transmission mode, it can only be made into a closed loop structure in one storage module. In this way, it is impossible to realize the vertical track of the vertical drive device 4 between adjacent storage modules. 1 across. Although the synchronous belt drive can be made into a non-closed and non-circulating structure, the synchronous belt must be tightened. If the synchronous belt is tightened, the synchronous belt can only be pulled from the two ends of the vertical track 1 to the back side of the vertical track 1 and tightened without making it into a closed loop in the storage module. After tightening, although the linear transmission can be realized under the premise that the synchronous belt is not closed and non-circulating, the synchronous pulley has extremely high requirements for meshing. When the horizontal power track 2 or the vertical track 1 of the adjacent storage module is aligned, due to The synchronous belt goes around from the two ends of the vertical track 1 to the backside of the horizontal power track 2 or the vertical track 1, therefore, this will cause the adjacent track ends to be unable to be closely connected. Once the connection cannot be compact, it cannot be guaranteed that the synchronous belt tooth pitch adjacent to the two different horizontal power rails 2 or vertical rails 1 at the junction is within the meshing requirements of the synchronous pulley. Then, when the horizontal drive device 5 or the vertical drive device 4. When it is necessary to cross the tracks between adjacent storage modules, it will inevitably result in that the positions between the adjacent horizontal power rails 2 or the vertical rails 1 cannot be meshed and thus the crossing cannot be completed. However, in the actual use of this embodiment, the adjacent horizontal power rails 2 are always in the joint state, while the adjacent vertical rails 1 are not always in the joint alignment state, and the joint state and non-joint state are driven by the horizontal driving device 5 Therefore, due to reasons such as installation accuracy, transmission error, vibration, etc., the vertical rail 1 between adjacent storage modules must fail to meet the meshing requirements of the synchronous pulley when entering the engagement state.

The transmission method of the ball screw requires the rotation of the screw to complete the linear drive. However, when the vertical rails 1 between adjacent storage modules enter the connected state from the non-connected state, it is also impossible to ensure that the connection between two adjacent lead screws can meet the transmission requirements of the nuts. Even if the problem of connecting adjacent lead screws is solved regardless of the cost, if the storage system has a high vertical extension, the rigidity of several lead screws connected to each other cannot be guaranteed. If the stiffness cannot be guaranteed, the vibration of the lead screw will be aggravated, which will cause the nut to drive poorly or even be damaged. Therefore, the way of the ball screw, no matter in terms of feasibility or cost, cannot meet the core requirement that the vertical driving device 4 crosses the vertical rail 1 between adjacent storage modules.

Therefore, the inventor has selectively used the transmission mode of the rack and pinion and the sprocket chain. For the transmission method of rack and pinion, the rack has a certain rigidity, and it does not need to be made into a closed transmission, nor does it need to be tightened. At the same time, the meshing requirements of the gears are much lower than those of the synchronous pulley. This also means that when the storage module is manufactured, the adjacent racks can be made into a relatively complete size that meets the gear meshing requirements, and then installed on different horizontal rails and vertical rails 1 respectively. When the vertical rails 1 between the adjacent storage modules enter the connected state from the non-joint state, as long as the vertical rails 1 are aligned, the adjacent racks can meet the meshing requirements of the gears, so that the vertical drive device 4 can move between the adjacent storage modules. The vertical rails 1 can be passed smoothly between the modules to complete the spanning. Regardless of the aspect of feasibility or cost, the core requirement that the vertical driving device 4 spans the vertical rail 1 between adjacent storage modules can be met. Since the horizontal power track 2 does not move up and down as a whole after the horizontal expansion, as long as the horizontal power track 2 is aligned, the adjacent racks can meet the meshing requirements of the gears, so that the driving device can move in the adjacent storage module. Can pass through horizontal track or vertical track 1 smoothly and finish spanning between. For the transmission mode of the sprocket chain, since the chain type is a semi-rigid transmission bar, the chain does not need to be tightened, and is directly fixed on the vertical track 1 through mechanical connection, which can also achieve the technical effect when the rack is docked. Although the synchronous belt is also the way of meshing, since the synchronous belt is a flexible belt, it must be tightened during the transmission process of the flexible belt, and the flexible belt can only be driven by the transmission belt. Therefore, even if the synchronous belt is in the form of a chain The mechanical connection is fixed on the vertical track 1, but only the synchronous wheel is driven, and the up and down movement still cannot be completed. At the same time, it is also because the timing belt is a flexible belt, so after a long time of use, the timing belt will inevitably loosen. In this way, it is even more impossible to complete the up and down movement.

At the same time, due to various reasons such as installation errors and manufacturing errors of the storage modules, when the vertical rails 1 are in the connected state, although good docking between adjacent vertical rails 1 can be achieved by virtue of the characteristics of the rack or chain, the error is still It exists. Then, the first guide wheel 41 and the second guide wheel 42 can possess certain elasticity, and when crossing the seam between adjacent vertical tracks 1, the guide wheels contact another vertical track 1 earlier than the gear or sprocket, the accumulated error can be overcome by the elasticity of the guide wheel itself. At this time, the vertical driving device 4 contacts two adjacent vertical rails 1 at the same time, creating good conditions for the smooth spanning of the gears or sprockets. Similarly, the third guide wheel 22 can also have a certain degree of elasticity. When crossing the laterally adjacent storage modules, the guide wheel contacts another horizontal power track 2 earlier than the gear, and can also overcome the accumulated load by the elasticity of the guide wheel itself. error. The horizontal driving device 5 contacts two adjacent horizontal power rails 2 at the same time, which also creates good conditions for the smooth spanning of the gears or sprockets.

In terms of electric control, as shown in FIG. 2 and FIG. 6, a horizontal electric rail is provided on the side of the horizontal guide rail 3, and a horizontal brush 8 is set on the beam 12, and the driving device and the handling device 6 are controlled by the horizontal brush 8 from Horizontal rails capture power. More specifically, a vertical electric rail 13 is provided on the side of the vertical rail 1, and the vertical electric rail 13 is electrically connected to the horizontal brush 8. The vertical driving device 4 is provided with a vertical brush 7, and the handling device 6, The horizontal driving device 5 and the vertical driving device 4 obtain electric energy from the horizontal electric rail through the vertical electric rail 13 and the horizontal electric brush 8 by the vertical electric brush 7. Moreover, the inventor also unexpectedly found that in order to meet the core requirement of the vertical drive device 4 to cross the vertical track 1 between adjacent storage modules, the transmission mode of the rack and pinion or the sprocket chain is adopted, and its power source Can only be arranged on one side of the gear or sprocket. It is precisely this centralized power layout that enables its control to be combined with the handling device 6 to achieve centralized location. In this way, no electrical components are needed on the vertical track 1, so that the structural layout of the storage module can be more reasonable and compact, and avoid excessive wiring from affecting the stable operation of the storage system. At the same time, it is also convenient for maintenance. Under special circumstances, the old transport device 6 can be directly removed, and the new transport device 6 can be directly replaced to realize rapid maintenance, and the vertical rail 1 is no longer required to be disassembled as a whole.

The end of the vertical electric rail 13 is provided with a connecting part, and the connecting part is an insulator. In the connected state, the driving device travels from any storage module along the vertical rail 1 to another adjacent storage module along the vertical rail 1 connected to each other, the vertical brush 7 enters the vertical electric rail 13 of another storage module through the connecting portion. Since the vertical driving device 4 crosses the storage modules along the vertical rails 1 connected to each other, there is also the situation of the vertical brushes 7 crossing the adjacent vertical electric rails 13 in terms of electric control. Due to the conductive effect of the vertical rails 13, when the vertical rails 1 of the vertically adjacent storage modules are in the connected state, there must be a large gap between the vertical rails 13 of the two vertical rails, because if the distance between adjacent vertical rails 13 is relatively close, arc discharge will occur. In order to ensure the safety of personnel and facilities, a sufficient safety distance must be left between adjacent vertical rails 13. And when the driving device reaches another adjacent storage module along the vertical track 1 from one storage module, it must be ensured that the vertical brush 7 can also cross from the vertical electric rail 13 of one storage module to the vertical rail 13 of another storage module. to rail 13. And because there is a safe distance between the adjacent vertical rails 13, therefore, through the insulated joint, the vertical brush 7 first enters the joint, and then enters the vertical electric cabinet through the joint, not only ensuring a safe distance to avoid causing While discharging, it also ensures the smooth operation of the driving device across the storage module.

The foregoing description, for purpose of explanation, has been described with reference to various embodiments and examples. However, the illustrative discussions above are not intended to be exhaustive or to limit the invention to the precise forms disclosed. Many modifications and variations are possible in view of the above teachings. The various embodiments and examples were chosen and described in order to best explain the principles of the invention and its practical applications, to thereby enable others skilled in the art to utilize the innovative technology with various modifications as may be suited to the particular use contemplated. For instance, it should be understood that the technology described herein can be practiced without these specific details in some cases. Further, various systems, devices, and structures are shown in block diagram form in order to avoid obscuring the description. For instance, various implementations are described as having particular hardware, software, and user interfaces.

In some instances, various implementations may be presented herein in terms of algorithms and symbolic representations of operations on data bits within a computer memory. An algorithm is here, and generally, conceived to be a self-consistent set of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout this disclosure, discussions utilizing terms such as “processing,” “computing,” “calculating,” “determining,” “displaying,” or the like, refer to the action and methods of a computer system that manipulates and transforms data represented as physical (electronic) quantities within the computer system's registers and memories into other data similarly represented as physical quantities within the computer system memories or registers or other such information storage, transmission or display devices.

A data processing system suitable for storing and/or executing program code, such as the computing system and/or devices discussed herein, may include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input or I/O devices can be coupled to the system either directly or through intervening I/O controllers. The data processing system may include an apparatus may be specially constructed for the required purposes, or it may comprise a general-purpose computer selectively activated or reconfigured by a computer program stored in the computer.

The foregoing description has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As will be understood by those familiar with the art, the specification may be embodied in other specific forms without departing from the spirit or essential characteristics thereof. Likewise, the particular naming and division of the modules, routines, features, attributes, methodologies and other aspects may not be mandatory or significant, and the mechanisms that implement the specification or its features may have different names, divisions, and/or formats.

Furthermore, the modules, routines, features, attributes, methodologies and other aspects of the disclosure can be implemented as software, hardware, firmware, or any combination of the foregoing. The technology can also take the form of a computer program product accessible from a computer-usable or computer-readable medium providing program code for use by or in connection with a computer or any instruction execution system. Wherever a component, an example of which is a module or engine, of the specification is implemented as software, the component can be implemented as a standalone program, as part of a larger program, as a plurality of separate programs, as a statically or dynamically linked library, as a kernel loadable module, as firmware, as resident software, as microcode, as a device driver, and/or in every and any other way known now or in the future. Additionally, the disclosure is in no way limited to implementation in any specific programming language, or for any specific operating system or environment. Accordingly, the disclosure is intended to be illustrative, but not limiting, of the scope of the subject matter set forth in the following claims.

What is claimed is:

1. A modularized storage system, comprising:
a driving device;
a handling device;
a plurality of storage modules, each storage module including a shelf body and a track located on the shelf body, wherein the track includes a vertical track and a horizontal track;
a plurality of horizontal rails coupled with the storage rack;
a plurality of vertical rails coupled with the horizontal rails;
wherein the driving device is configured drive the handling device along the vertical track and the horizontal track and the handling device is configured to manipulate items on the shelf body.
